(19) United States
(12) Patent Application Publication
(10) Pub. No.: US 2023/0080124 A1
(43) Pub. Date: Mar. 16, 2023

(54) BROADBAND CAPACITOR

(71) Applicant: AMOTECH CO., LTD., Incheon (KR)

(72) Inventors: Byungguk LIM, Incheon (KR); Seungchul LEE, Incheon (KR); Heehwang KIM, Incheon (KR); Junseok OH, Incheon (KR)

(73) Assignee: AMOTECH CO., LTD., Incheon (KR)

(21) Appl. No.: 17/799,247

(22) PCT Filed: Feb. 5, 2021
(86) PCT No.: PCT/KR2021/001520

§ 371 Date: Aug. 11, 2022

(30) Foreign Application Priority Data
Feb. 11, 2020 (KR) 10-2020-0016418

(51) Int. Cl. H01G 4/012; H01G 4/06; H01G 4/232; H01G 4/30

(52) U.S. Cl. CPC H01G 4/012; H01G 4/06; H01G 4/232; H01G 4/30

(57) ABSTRACT

Disclosed is a broadband capacitor including floating electrodes arranged above and below a laminate in which electrode units are laminated to allow easy change of the characteristic (that is, a capacitance value) of a capacitor. The disclosed broadband capacitor comprises: a dielectric; a first external electrode; a second external electrode; a laminate, which is disposed in the dielectric and in which a plurality of electrode units are laminated; an upper floating electrode disposed in the dielectric, disposed above the laminate, and overlapping the first external electrode and the second external electrode; and a lower floating electrode disposed in the dielectric, disposed below the laminate, and overlapping the first external electrode and the second external electrode.

### TECHNICAL FIELD

The present disclosure relates to a broadband capacitor, and more specifically, to a broadband capacitor used in an optical transceiver, a transmitter optical sub assembly (TOSA), a receiver optical sub assembly (ROSA), and the like configuring a high-speed communication network.

### BACKGROUND ART

A conventional broadband capacitor is configured by laminating a plurality of electrode units composed of a main electrode having an extension arm formed at a side of one end and a C-type electrode surrounding the other end of the main electrode. The conventional broadband capacitor implements broadband characteristics by forming a primary capacitance through overlapping between the main electrodes and forming a secondary capacitance between the C-type electrode and the main electrode to increase the capacitance.

However, the conventional broadband capacitor has a problem in that it is difficult to change the capacitance value because a range in which an area of the main electrode may be changed is limited due to the end to which the extension arm and the main electrode are connected and the C-type electrode.

### SUMMARY OF INVENTION

### Technical Problem

The present disclosure has been proposed to solve the above problem, and an object of the present disclosure is to provide a broadband capacitor, which facilitates a change in characteristic of a capacitor (i.e., a capacitance value) by disposing a floating electrode above and below a laminate in which electrode units are laminated.

### Solution to Problem

In order to achieve the object, a broadband capacitor according to an embodiment of the present disclosure includes a dielectric having an upper surface, a lower surface, a first side surface, a second side surface facing the first side surface, a third side surface, and a fourth side surface facing the third side surface, a first external electrode disposed on the first side surface of the dielectric, and extending to the upper surface, lower surface, third side surface, and fourth side surface of the dielectric, a second external electrode disposed on the second side surface of the dielectric, and extending to the upper surface, lower surface, third side surface, and fourth side surface of the dielectric, a laminate disposed inside the dielectric, and having a plurality of electrode units laminated, an upper floating electrode disposed inside the dielectric and disposed above the laminate, and overlapping the first external electrode and the second external electrode, and a lower floating electrode disposed inside the dielectric, disposed below the laminate, and overlapping the first external electrode and the second external electrode.

The plurality of electrode units may include a first electrode set provided with a first main electrode having a first side connected to the first external electrode and a second electrode set provided with a second main electrode having a first side connected to the second external electrode, the laminate may be formed by alternately laminated the first electrode set and the second electrode set, a second side of the first main electrode may be spaced apart from the second external electrode, the second side of the first main electrode may be spaced apart from the first external electrode, and a part of the first main electrode may overlap a part of the second main electrode to form an overlapping area. At this time, the upper floating electrode and the lower floating electrode may overlap the overlapping area between the first main electrode and the second main electrode.

The first electrode set may further include a first sub-electrode spaced apart from the first main electrode and disposed to face the second side of the first main electrode, and connected to the second external electrode, and the second electrode set further includes a second sub-electrode spaced apart from the second main electrode and disposed to face a second side of the second main electrode, and connected to the first external electrode.

The first electrode set may further include a first extension electrode extending from a third side of the first main electrode parallel to the third side surface of the dielectric and extending from a position adjacent to the first side of the first main electrode, and bent toward the second side of the first main electrode from a position spaced apart from the third side of the first main electrode and a second extension electrode extending from a fourth side of the first main electrode parallel to the fourth side surface of the dielectric and extending from the position adjacent to the first side of the first main electrode, and bent toward the second side of the first main electrode from a position spaced apart from the fourth side of the first main electrode, and the second electrode set may further include a third extension electrode extending from a third side of the second main electrode parallel to the third side surface of the dielectric and extending from a position adjacent to the first side of the second main electrode, and bent toward the second side of the first main electrode from a position spaced apart from the third side of the second main electrode and a fourth extension electrode extending from a fourth side of the second main electrode parallel to the fourth side surface of the dielectric and extending from the position adjacent to the first side of the second main electrode, and bent toward the second side of the second main electrode from the position spaced apart from the fourth side of the second main electrode.

The first electrode set may further include a first expansion electrode extending from a third side of the first main electrode parallel to the third side surface of the dielectric and extending toward the third side surface of the dielectric from a position adjacent to the first side of the first main electrode and a second expansion electrode extending from a fourth side of the first main electrode parallel to the fourth side surface of the dielectric and extending toward the fourth side surface of the dielectric from the position adjacent to the first side of the first main electrode, and the second electrode set may further include a third expansion electrode extending from a third side of the second main electrode parallel to the third side surface of the dielectric and extending toward the third side surface of the dielectric from a position adjacent to the first side of the second main electrode and a fourth expansion electrode extending from a third side of the second main electrode parallel to the third side surface of the dielectric and extending toward the fourth side surface of the dielectric from the position adjacent to the first side of the second main electrode.

The upper floating electrode and the lower floating electrode may have a multi-layer structure in which a plurality of dielectric sheets on which a floating electrode is disposed are laminated.

The broadband capacitor according to an embodiment of the present disclosure may further include one or more among a first dummy electrode disposed inside the dielectric and disposed above the laminate, disposed adjacent to the first side surface of the dielectric, and connected to the first external electrode, a second dummy electrode disposed inside the dielectric and disposed below the laminate, disposed adjacent to the first side surface of the dielectric, and connected to the first external electrode, a third dummy electrode disposed inside the dielectric and disposed above the laminate, disposed adjacent to the second side surface of the dielectric, and connected to the second external electrode, and a fourth dummy electrode disposed inside the dielectric and disposed below the laminate, disposed adjacent to the second side surface of the dielectric, and connected to the second external electrode. At this time, the first dummy electrode, the second dummy electrode, the third dummy electrode, and the fourth dummy electrode may have a multi-layer structure in which a plurality of dielectric sheets on which the dummy electrodes are disposed are laminated.

The broadband capacitor according to an embodiment of the present disclosure may further include one or more among a first stub electrode disposed inside the dielectric and disposed above the laminate, disposed adjacent to the first side surface of the dielectric, and connected to the first external electrode, a second stub electrode disposed inside the dielectric and disposed below the laminate, disposed adjacent to the first side surface of the dielectric, and connected to the first external electrode, a third stub electrode disposed inside the dielectric and disposed above the laminate, disposed adjacent to the second side surface of the dielectric, and connected to the second external electrode, and a fourth stub electrode disposed inside the dielectric and disposed below the laminate, disposed adjacent to the second side surface of the dielectric, and connected to the second external electrode. At this time, the first stub electrode, the second stub electrode, the third stub electrode, and the fourth stub electrode may have a multi-layer structure in which a plurality of dielectric sheets on which the stub electrodes are disposed are laminated.

In the first stub electrode and the second stub electrode, a first area disposed adjacent to the first side surface of the dielectric, and connected to the first external electrode, a second area connected to a first end of the first area disposed to face the third side surface of the dielectric, and a third area connected to a second end of the first area disposed to face the fourth side surface of the dielectric may be defined, and in the third stub electrode and the fourth stub electrode, a first area disposed adjacent to the second side surface of the dielectric, and connected to the second external electrode, a second area connected to a first end of the first area disposed to face the third side surface of the dielectric, and a third area connected to a second end of the first area disposed to face the fourth side surface of the dielectric may be defined.

The first stub electrode and the third stub electrode may be disposed on a first dielectric sheet disposed above the laminate, and the second stub electrode and the fourth stub electrode may be disposed on a second dielectric sheet disposed below the laminate.

### Advantageous Effects of Invention

According to the present disclosure, the broadband capacitor can increase the capacitance compared to the conventional capacitor when manufactured to have the same size as that of the general capacitor, thereby maintaining the loss of the reference value or less in the range of the wide frequency band to cover the broadband.

In addition, the broadband capacitor can expand the main electrode to the position close to the external electrode not electrically connected, thereby implementing the required capacitance value through the change in the length of the main electrode to increase the degree of freedom in the capacitance value even in the small area.

In addition, the broadband capacitor can further reduce the resonance level by configuring the multi-layered floating electrode.

### BRIEF DESCRIPTION OF DRAWINGS

FIG. 1 is a view for describing a broadband capacitor according to an embodiment of the present disclosure.

FIGS. 2 and 3 are views for describing an electrode unit disposed in a dielectric in FIG. 1.

FIG. 4 is a view for describing characteristics of the broadband capacitor including the electrode unit.

FIGS. 5 and 6 are views for describing a floating electrode disposed in the dielectric in FIG. 1.

FIG. 7 is a view for describing characteristics of the broadband capacitor according to a change in a length of an external electrode.

FIGS. 8 and 9 are views for describing a structure of the broadband capacitor including the floating electrode.

FIGS. 10 and 11 are views for describing a multi-layer structure of the floating electrode.

FIGS. 12 and 13 are views for describing one embodiment of the electrode unit.

FIGS. 14 and 15 are views for describing another embodiment of the electrode unit.

FIGS. 16 and 17 are views for describing still another embodiment of the electrode unit.

FIG. 18 is a view for describing a characteristic of the broadband capacitor according to a structure of the electrode unit.

FIG. 19 is a view for describing a structure of the broadband capacitor including a dummy electrode.

FIG. 20 is a view for describing a structure of the broadband capacitor including a dummy electrode having a multi-layer structure.

FIGS. 21 and 22 are views for describing a structure of the broadband capacitor including a stub electrode.

FIG. 23 is a view for describing a structure of the stub electrode in FIG. 21.

FIG. 24 is a view for describing a structure of the broadband capacitor including the stub electrode having a multi-layer structure.

FIG. 25 is a view for describing a characteristic of the broadband capacitor according to a change in an electrode width of the electrode unit.

### DESCRIPTION OF EMBODIMENTS

Hereinafter, the most preferred embodiments of the present disclosure will be described with reference to the accompanying drawings in order to specifically describe the embodiments so that those skilled in the art to which the present disclosure pertains can easily implement the technical spirit of the present disclosure. First, in adding reference numerals to the components of each drawing, it should be noted that the same components have the same reference numerals as much as possible even if they are illustrated in different drawings. In addition, in describing the present disclosure, when it is determined that the detailed description of the related well-known configuration or function can obscure the gist of the present disclosure, the detailed description thereof will be omitted.

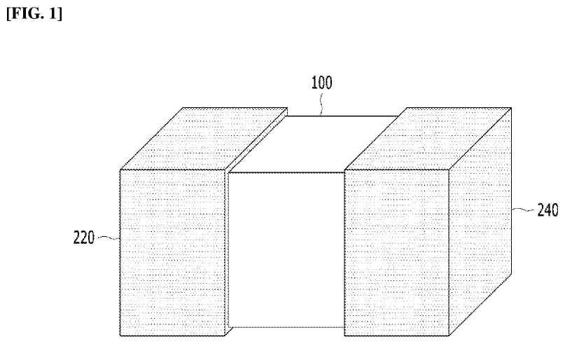

Referring to FIG. 1, a broadband capacitor according to an embodiment of the present disclosure is configured to include a dielectric 100, a first external electrode 220, and a second external electrode 240.

The dielectric 100 is configured as a rectangular parallelepiped having an upper surface, a lower surface, a first side surface, a second side surface facing the first side surface, a third side surface, and a fourth side surface facing the third side surface, and for example, the first side surface is a left side in the drawing, the second side surface is a right side in the drawing, the third side surface is a front side in the drawing, and the fourth side surface is a back side in the drawing. At this time, the dielectric 100 may be configured by laminating a plurality of dielectric sheets 110 on which an electrode unit 300 is formed.

The first external electrode 220 is an electrode disposed on the first side surface of the dielectric 100. The first external electrode 220 and the second external electrode 240 may be formed to extend from the first side surface of the dielectric 100 to the upper surface, lower surface, third side surface, and fourth side surface of the dielectric 100.

The second external electrode 240 is an electrode disposed on the second side surface of the dielectric 100. The second external electrode 240 and the second external electrode 240 may be formed to extend from the second side surface of the dielectric 100 to the upper surface, lower surface, third side surface, and fourth side surface of the dielectric 100.

At this time, the first external electrode 220 and the second external electrode 240 may be spaced apart from the upper surface, lower surface, third side surface, the fourth side surface of the dielectric 100 by a predetermined interval to face each other.

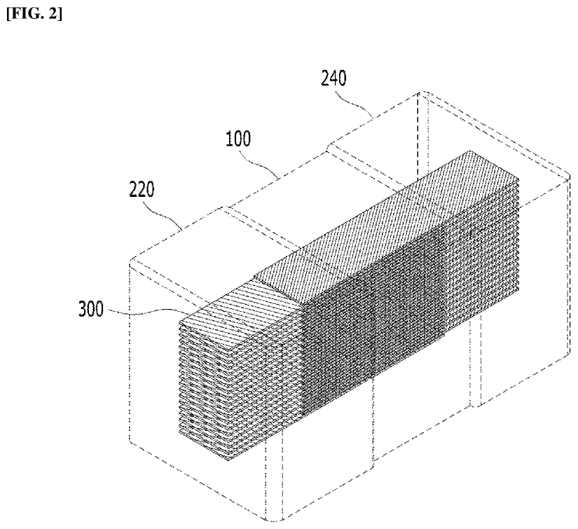

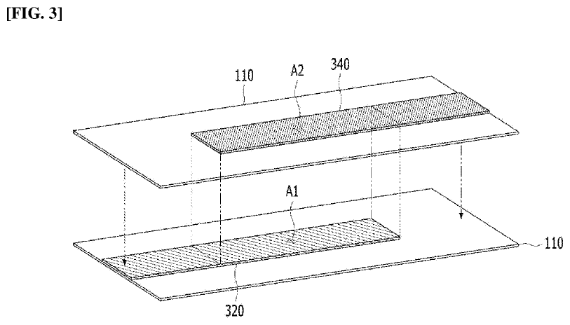

Referring to FIGS. 2 and 3, the broadband capacitor according to the embodiment of the present disclosure may be configured to further include a plurality of electrode units 300. At this time, the plurality of electrode units 300 are laminated to form a laminate, and the laminate is disposed inside the dielectric 100.

The plurality of electrode units 300 are vertically laminated in the drawings and disposed inside the dielectric 100. Each electrode unit 300 includes a first electrode set 320 and a second electrode set 340, and is configured by alternately laminating the first electrode set 320 and the second electrode set 340.

The first electrode set 320 is configured as a plate-shaped conductor formed in a rectangular shape. The first electrode set 320 is disposed to be biased to the first side surface of the dielectric 100 inside the dielectric 100. A first end of the first electrode set 320 is connected to the first external electrode 220 on the first side surface of the dielectric 100. The first electrode set 320 has a first side electrically connected to the first external electrode 220, a second side facing the first side, a third side disposed toward one ends of the first side and the second side, and a fourth side disposed toward the other ends of the first side and the second side to face the third side.

The second electrode set 340 is configured as a plate-shaped conductor formed in a rectangular shape. The second electrode set 340 is disposed to be biased to the second side surface of the dielectric 100 inside the dielectric 100. A first end of the second electrode set 340 is connected to the second external electrode 240 on the second side surface of the dielectric 100. The second electrode set 340 has a first side electrically connected to the second external electrode 240, a second side facing the first side, a third side disposed toward one ends of the first side and the second side, and a fourth side disposed toward the other ends of the first side and the second side to face the third side.

The first electrode set 320 and the second electrode set 340 are disposed to be dispersed on two adjacent dielectric sheets 110, respectively, among a plurality of dielectric sheets 110 configuring the dielectric sheet 110. The first electrode set 320 and the second electrode set 340 partially overlap each other with the dielectric sheet 110 interposed therebetween.

Accordingly, the first electrode set 320 and the second electrode set 340 are alternately laminated inside the dielectric 100 to form overlapping areas A1 and A2, and form capacitances in the overlapping areas A1 and A2.

Characteristics of the broadband capacitor may be adjusted (improved) by adjusting lengths L1 of the first external electrode 220 and the second external electrode 240. In other words, the characteristics of the broadband capacitor may be adjusted by adjusting a separation distance L2 between the first external electrode 220 and the second external electrode 240.

In other words, the characteristics of the broadband capacitor may be adjusted by changing the lengths L1 of the first external electrode 220 and the second external electrode 240 to change the separation distance L2 between the first external electrode 220 and the second external electrode 240 on the upper surface, lower surface, third side surface, and fourth side surface of the dielectric 100 upon manufacturing. At this time, the broadband capacitor may adjust the separation distance L2 between the first external electrode 220 and the second external electrode 240 within a range in which electrical interference does not occur between the first external electrode 220 and the second external electrode 240.

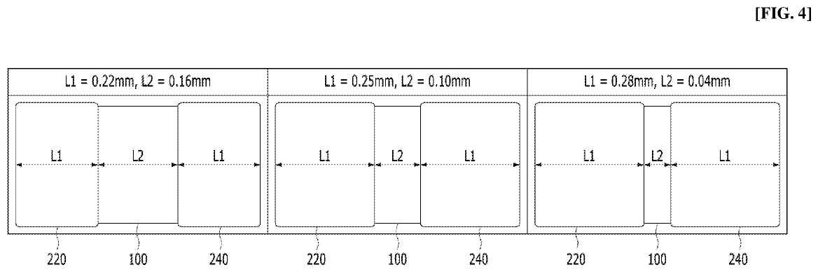

For example, referring to FIG. 4, the broadband capacitor has the plate-shaped first electrode set 320 and second electrode set 340 having a rectangular shape disposed inside the dielectric 100. When the lengths L1 of the first external electrode 220 and the second external electrode 240 are formed to about 0.22 mm, the separation distance L2 between the first external electrode 220 and the second external electrode 240 is formed to about 0.16 mm. When the lengths L1 of the first external electrode 220 and the second external electrode 240 are formed to about 0.25 mm, the separation distance L2 between the first external electrode 220 and the second external electrode 240 are formed to about 0.1 mm. When the lengths L1 of the first external electrode 220 and the second external electrode 240 are formed to about 0.28 mm, the separation distance L2 between the first external electrode 220 and the second external electrode 240 is formed to about 0.04 mm.

At this time, when the lengths L1 of the first external electrode 220 and the second external electrode 240 or the separation distance L2 between the first external electrode 220 and the second external electrode 240 are differently formed, in the broadband capacitor, a frequency band in which resonance occurs and a resonance level in each frequency band are changed.

Accordingly, the characteristics of the broadband capacitor according to the embodiment of the present disclosure are improved as the lengths L1 of the first external electrode 220 and the second external electrode 240 increases, and the resonance frequency band and the resonance level may be adjusted by adjusting the length L1 of the first external electrode 220 and the length L1 of the second external electrode 240 (i.e., the separation distance L2 between the first external electrode 220 and the second external electrode 240).

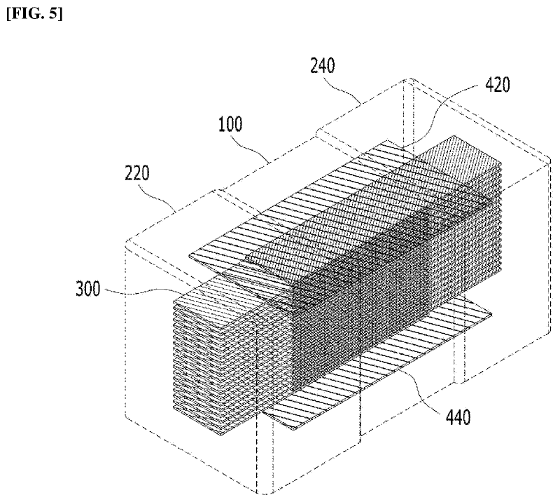

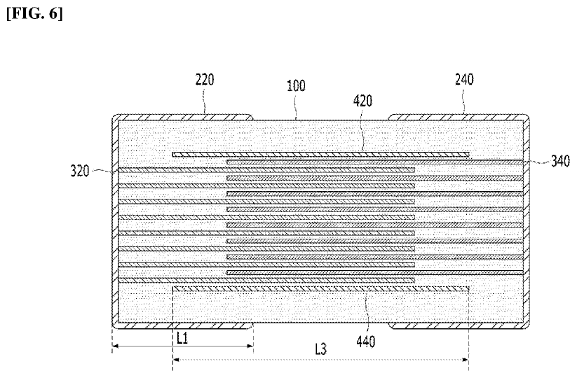

Referring to FIGS. 5 and 6, the broadband capacitor according to the embodiment of the present disclosure may be configured to further include an upper floating electrode 420 and a lower floating electrode 440. At this time, the upper floating electrode 420 and the lower floating electrode 440 are disposed inside the dielectric 100. Each of the upper floating electrode 420 and the lower floating electrode 440 is disposed on the dielectric sheet 110 configuring the dielectric 100, and disposed inside the dielectric 100 as the plurality of dielectric sheets 110 are laminated to form the dielectric 100.

The upper floating electrode 420 is configured as a plate-shaped conductor. The upper floating electrode 420 is disposed above the laminate in which the plurality of electrode units 300 are laminated. The upper floating electrode 420 is spaced apart from the electrode set disposed at an uppermost portion of the laminate by a predetermined distance, and the dielectric 100 layer is interposed therebetween.

The lower floating electrode 440 is configured as a plate-shaped conductor. The lower floating electrode 440 is disposed below the laminate in which the plurality of electrode units 300 are laminated. The lower floating electrode 440 is spaced apart from the electrode set disposed at a lowermost portion of the laminate by a predetermined distance, and the dielectric 100 layer is interposed therebetween.

The lower floating electrode 440 may be configured by laminating a plurality of plate-shaped conductors. At this time, each of the plurality of plate-shaped conductors is disposed on the dielectric sheet 110, and as the dielectric sheets 110 are laminated, the dielectric 100 layer is interposed between the plurality of plate-shaped conductors.

The upper floating electrode 420 and the lower floating electrode 440 are disposed to face each other with respect to the laminate, and disposed to at least partially overlap the first external electrode 220 and the second external electrode 240.

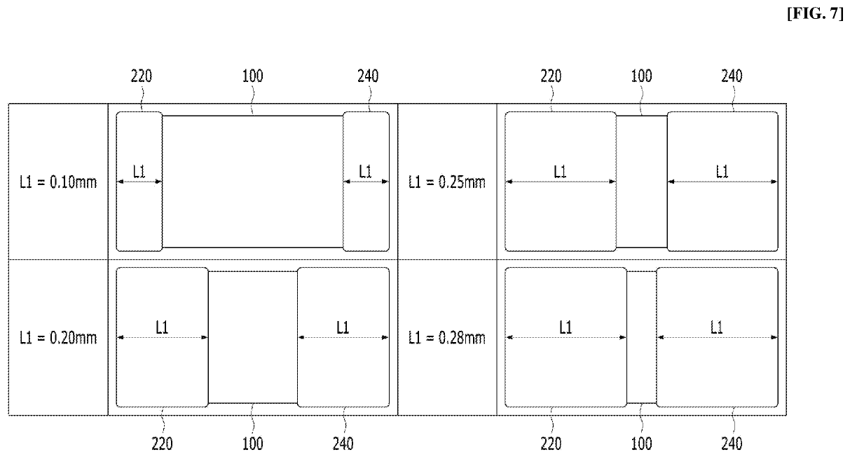

Referring to FIG. 7, even when the broadband capacitor includes the upper floating electrode 420, in the broadband capacitor, the changed frequency band in which resonance occurs in the wideband capacitor and the resonance level in each frequency band are changed when the lengths L1 of the first external electrode 220 and the second external electrode 240 or the separation distance L2 between the first external electrode 220 and the second external electrode 240 are formed differently.

Accordingly, the characteristics of the broadband capacitor according to the embodiment of the present disclosure are improved as the lengths L1 of the first external electrode 220 and the second external electrode 240 increases, and the resonance frequency band and the resonance level may be adjusted by adjusting the length L1 of the first external electrode 220 and the length L1 of the second external electrode 240 or the separation distance L2 between the first external electrode 220 and the second external electrode 240.

Meanwhile, lengths of the floating electrodes (i.e., the upper floating electrode 420 and the lower floating electrode 440) may be limited according to the lengths of the external electrodes (i.e., the first external electrode 220 and the second external electrode 240).

When the length L1 of the external electrode is 200 μm, the resonant frequency of the broadband capacitor is shifted to the low frequency band as a length L3 of the floating electrode increases. In other words, in the broadband capacitor, it is advantageous in securing capacitor performance (e.g., capacitance) as the length L3 of the floating electrode increases when the length L1 of the external electrode is 200 μm.

However, when the length L1 of the external electrode is 250 μm, the resonance frequency of the broadband capacitor is shifted to the lower frequency band as the length L3 of the floating electrode decreases. In other words, in the broadband capacitor, it is advantageous in securing capacitor performance as the length L3 of the floating electrode decreases when the length L1 of the external electrode is 250 μm.

Accordingly, the length L3 of the floating electrode is limited according to the length L1 of the external electrode.

The broadband capacitor may adjust the capacitor performance by changing a position of the floating electrode.

For example, the broadband capacitor may be classified into a first structure, a second structure, and a third structure according to the positions of the upper floating electrode 420 and the lower floating electrode 440.

Referring to FIG. 6, the first structure is a structure in which the upper floating electrode 420 is disposed closer to the electrode set disposed at the uppermost portion than an upper surface of the dielectric 100, and the lower floating electrode 440 is disposed closer to the electrode set disposed at the lowermost portion than a lower surface of the dielectric 100. In other words, the first structure is a structure in which a gap between the floating electrode and the electrode set is smaller than a gap between the floating electrode and the surface of the dielectric 100.

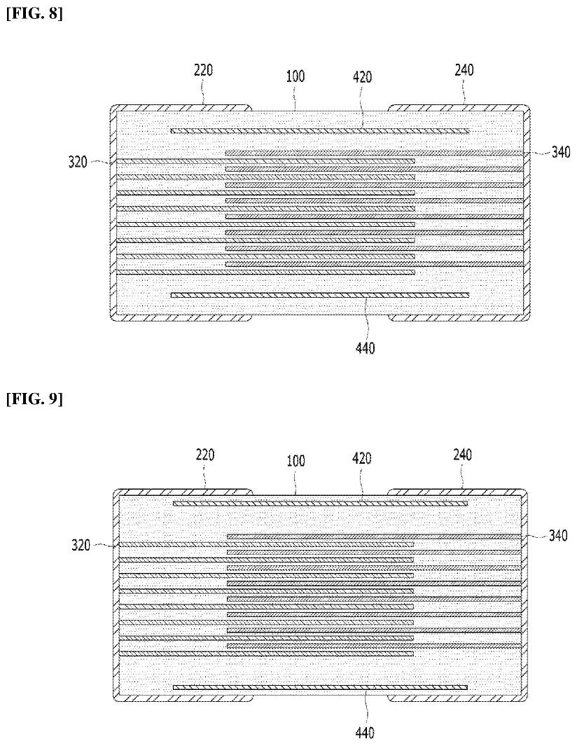

Referring to FIG. 8, the second structure is a structure in which the upper floating electrode 420 is disposed to be spaced apart from the upper surface of the dielectric 100 by the same distance as the distance spaced apart from the electrode set disposed at the uppermost portion, and the lower floating electrode 440 is disposed to be spaced apart from the lower surface of the dielectric 100 by the same distance as the distance spaced apart from the electrode set disposed at the lowermost portion. In other words, the second structure is a structure in which an interval between the floating electrode and the electrode set is the same as an interval between the floating electrode and the surface of the dielectric 100.

Referring to FIG. 9, the third structure is a structure in which the upper floating electrode 420 is disposed closer to the upper surface of the dielectric 100 than the electrode set disposed at the uppermost portion, and the lower floating electrode 440 is disposed closer to the lower surface of the dielectric 100 than the electrode set disposed at the lowermost portion. In other words, the third structure is a structure in which an interval between the floating electrode and the electrode set is greater than an interval between the floating electrode and the surface of the dielectric 100.

The broadband capacitor has the changed frequency band in which resonance occurs and the changed resonance level in each frequency band as the positions of the upper floating electrode 420 and the lower floating electrode 440 are changed. Accordingly, the broadband capacitor may adjust the capacitor performance by changing the position of the floating electrode.

The broadband capacitor may adjust the capacitor performance by changing a thickness of the floating electrode (i.e., the number of laminated electrode plates). In the broadband capacitor, capacitor performance varies depending on the thickness of the floating electrode. The floating electrode may be configured by laminating a plurality of electrode plates. At this time, each of the plurality of electrode plates is disposed on the dielectric sheet 110, and as the dielectric sheets 110 are laminated, the dielectric 100 layer is interposed between the plurality of electrode plates.

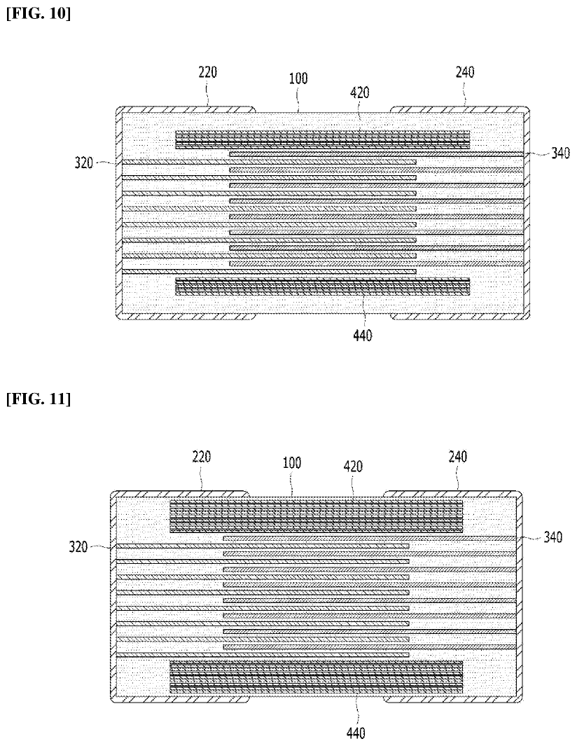

For example, the broadband capacitor may be classified into a single-layer structure having one floating electrode (see FIG. 6), a five-layer structure having five floating electrodes (see FIG. 10), a nine-layer structure having nine floating electrodes (see FIG. 11), and the like. At this time, the floating electrode is disposed on the dielectric sheet 110 configuring the dielectric 100, and as the plurality of dielectric sheets 110 are laminated, the floating electrode overlaps another floating electrode with the dielectric sheet 110 interposed therebetween.

The broadband capacitor has the changed frequency band in which resonance occurs and the changed resonance level in each frequency band as the number of upper floating electrodes 420 and lower floating electrodes 440 laminated is changed. Accordingly, the broadband capacitor may adjust the capacitor performance by changing the number of laminated electrode plates configuring the floating electrode.

Meanwhile, the first electrode set 320 and the second electrode set 340 may be changed into various shapes to adjust the capacitor performance.

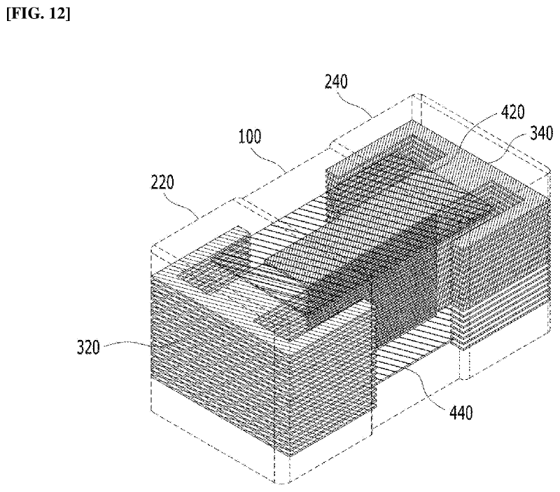

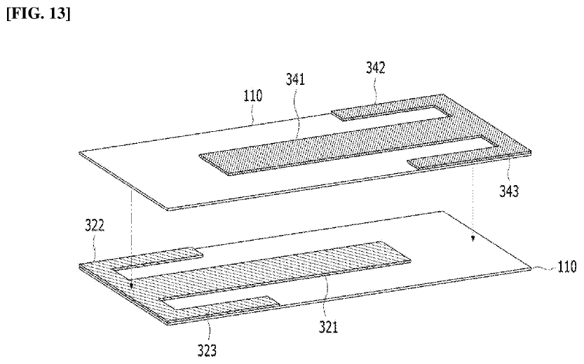

For example, referring to FIGS. 12 and 13, the first electrode set 320 may be configured to include a first main electrode 321, a first extension electrode 322, and a second extension electrode 323. The first electrode set 320 may be formed in a “⊥” shape by the first main electrode 321, the first extension electrode 322, and the second extension electrode 323.

The first main electrode 321 is configured as a plate-shaped conductor formed in a rectangular shape. The first main electrode 321 has a first side electrically connected to the first external electrode 220, a second side facing the first side, a third side disposed toward one ends of the first side and the second side, and a fourth side disposed toward the other ends of the first side and the second side to face the third side. The first extension electrode 322 is configured as a plate-shaped conductor. The first extension electrode 322 extends from the third side of the first main electrode 321, and extends from a position adjacent to the first side of the first main electrode 321. The first extension electrode 322 is bent toward the second side from a position spaced apart from the third side of the first main electrode 321 by a predetermined distance. Accordingly, the first extension electrode 322 has a vertical area perpendicular to the first main electrode 321 and a horizontal area parallel to the first main electrode 321.

The second extension electrode 323 is configured as a plate-shaped conductor. The second extension electrode 323 extends from the fourth side of the first main electrode 321, and extends from the position adjacent to the first side of the first main electrode 321. The second extension electrode 323 is bent toward the second side from a position spaced apart from the fourth side of the first main electrode 321 by a predetermined distance. Accordingly, the second extension electrode 323 has a vertical area perpendicular to the first main electrode 321 and a horizontal area parallel to the first main electrode 321.

The second electrode set 340 may be configured to include a second main electrode 341, a third extension electrode 342, and a fourth extension electrode 343. The second electrode set 340 may be formed in a “⊥” shape by the second main electrode 341, the third extension electrode 342, and the fourth extension electrode 343.

The second main electrode 341 is configured as a plate-shaped conductor formed in a rectangular shape. The second main electrode 341 has a first side electrically connected to the second external electrode 240, a second side facing the first side, a third side disposed toward one ends of the first side and the second side, and a fourth side disposed toward the other ends of the first side and the second side to face the third side.

The third extension electrode 342 is configured as a plate-shaped conductor. The third extension electrode 342 extends from the third side of the second main electrode 341, and extends from a position adjacent to the first side of the second main electrode 341. The third extension electrode 342 is bent toward the second side from a position spaced apart from the third side of the second main electrode 341 by a predetermined distance. Accordingly, the third extension electrode 342 has a vertical area perpendicular to the second main electrode 341 and a horizontal area parallel to the first main electrode 321.

The fourth extension electrode 343 is configured as a plate-shaped conductor. The fourth extension electrode 343 extends from the fourth side of the second main electrode 341, and extends from the position adjacent to the first side of the second main electrode 341. The fourth extension electrode 343 is bent toward the second side from a position spaced apart from the fourth side of the second main electrode 341 by a predetermined distance. Accordingly, the fourth extension electrode 343 has a vertical area perpendicular to the second main electrode 341 and a horizontal area parallel to the first main electrode 321.

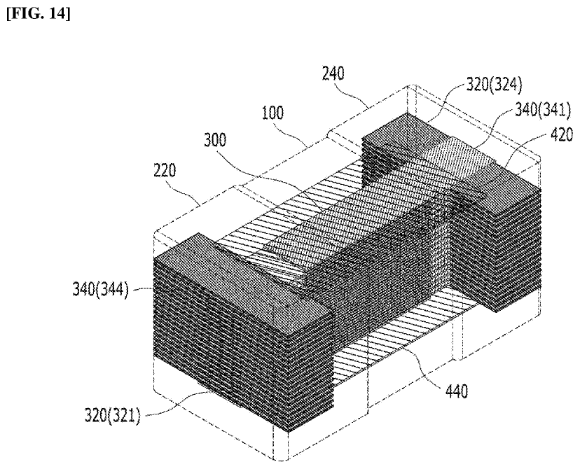

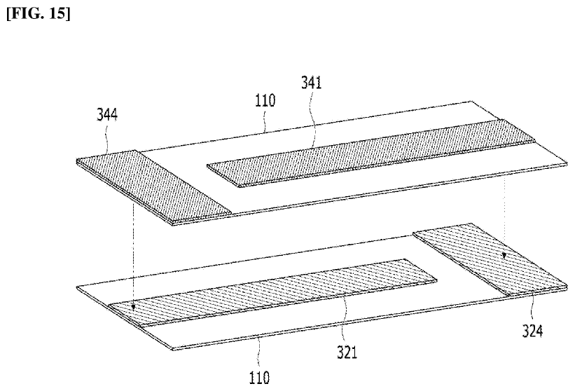

As another example, referring to FIGS. 14 and 15, the first electrode set 320 may be configured to include the first main electrode 321 and a first sub-electrode 324.

The first main electrode 321 is configured as a plate-shaped conductor formed in a rectangular shape. The first main electrode 321 has a first side electrically connected to the first external electrode 220, a second side facing the first side, a third side disposed toward one ends of the first side and the second side, and a fourth side disposed toward the other ends of the first side and the second side to face the third side.

The first sub-electrode 324 is configured as a plate-shaped conductor formed in a rectangular shape, and is spaced apart from the first main electrode 321 by a predetermined interval. The first sub-electrode 324 is disposed to face the second side of the first main electrode 321, and spaced apart from the second side of the first main electrode 321 by a predetermined interval. At this time, the first sub-electrode 324 is disposed on the same dielectric sheet 110 as the first main electrode 321, and electrically connected to the second external electrode 240.

The second electrode set 340 may be configured to include the second main electrode 341 and a second sub-electrode 344.

The second main electrode 341 is configured as a plate-shaped conductor formed in a rectangular shape. The second main electrode 341 has a first side electrically connected to the second external electrode 240, a second side facing the first side, a third side disposed toward one ends of the first side and the second side, and a fourth side disposed toward the other ends of the first side and the second side to face the third side.

The second sub-electrode 344 is configured as a plate-shaped conductor formed in a rectangular shape, and spaced apart from the second main electrode 341 by a predetermined interval. The second sub-electrode 344 is disposed to face the second side of the second main electrode 341, and spaced apart from the second side of the second main electrode 341 by a predetermined interval. At this time, the second sub-electrode 344 is disposed on the same dielectric sheet 110 as the second main electrode 341, and electrically connected to the first external electrode 220.

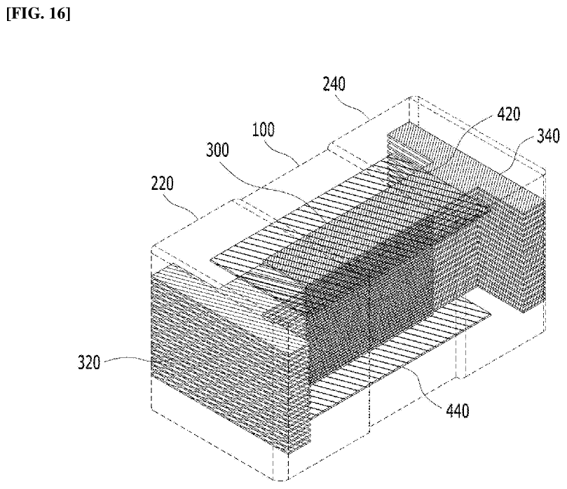

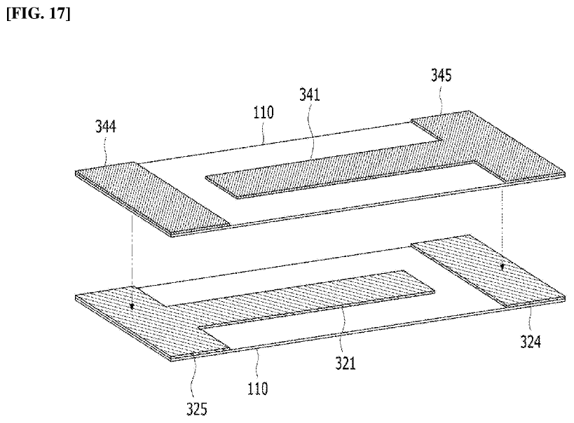

As still another example, referring to FIGS. 16 and 17, the first electrode set 320 may be configured to include the first main electrode 321, a first expansion electrode 325, and a second expansion electrode 345. The first electrode set 320 may be formed in a “⊥” shape by the first main electrode 321, the first expansion electrode 325, and the second expansion electrode 345.

The first main electrode 321 is configured as a plate-shaped conductor formed in a rectangular shape. The first main electrode 321 has a first side electrically connected to the first external electrode 220, a second side facing the first side, a third side disposed toward one ends of the first side and the second side, and a fourth side disposed toward the other ends of the first side and the second side to face the third side.

The first expansion electrode 325 is configured as a plate-shaped conductor. The first expansion electrode 325 extends from the third side of the first main electrode 321, and extends from the position adjacent to the first side of the first main electrode 321.

The second expansion electrode 345 is configured as a plate-shaped conductor. The second expansion electrode 345 extends from the fourth side of the first main electrode 321, and extends from the position adjacent to the first side of the first main electrode 321.

The second electrode set 340 may be configured to include the second main electrode 341, a third expansion electrode, and a fourth expansion electrode. The second electrode set 340 may be formed in a “⊥” shape by the second main electrode 341, the third expansion electrode, and the fourth expansion electrode.

The second main electrode 341 is configured as a plate-shaped conductor formed in a rectangular shape. The second main electrode 341 has a first side electrically connected to the second external electrode 240, a second side facing the first side, a third side disposed toward one ends of the first side and the second side, and a fourth side disposed toward the other ends of the first side and the second side to face the third side.

The third expansion electrode is configured as a plate-shaped conductor. The third expansion electrode extends from the third side of the second main electrode 341, and extends from the position adjacent to the first side of the second main electrode 341.

The fourth expansion electrode is configured as a plate-shaped conductor. The fourth expansion electrode extends from the fourth side of the second main electrode 341, and extends from the position adjacent to the first side of the second main electrode 341.

Referring to FIGS. 16 and 17, the first electrode set 320 may be configured to further include the first sub-electrode 324.

The first sub-electrode 324 is configured as a plate-shaped conductor formed in a rectangular shape, and is spaced apart from the first main electrode 321 by a predetermined interval. The first sub-electrode 324 is disposed to face the second side of the first main electrode 321, and spaced apart from the second side of the first main electrode 321 by a predetermined interval. At this time, the first sub-electrode 324 is disposed on the same dielectric sheet 110 as the first main electrode 321, and electrically connected to the second external electrode 240.

The second sub-electrode 344 is configured as a plate-shaped conductor formed in a rectangular shape, and spaced apart from the second main electrode 341 by a predetermined interval. The second sub-electrode 344 is disposed to face the second side of the second main electrode 341, and spaced apart from the second side of the second main electrode 341 by a predetermined interval. At this time, the second sub-electrode 344 is disposed on the same dielectric sheet 110 as the second main electrode 341, and electrically connected to the first external electrode 220.

Referring to FIG. 18, an internal electrode pattern disposed inside the dielectric 100 may be composed of about five combinations. In other words, the internal electrode pattern may be composed of about five combinations according to the shapes of the first electrode set 320 and the second electrode set 340.

When the length L1 of the external electrode is 200 μm. the broadband capacitor has a changed frequency band in which resonance occurs and a changed resonance level in each frequency band as the internal electrode pattern is changed. Accordingly, the broadband capacitor may adjust the capacitor performance by changing the internal electrode pattern.

At this time, although the shape and configuration of the internal electrode pattern is changed, the broadband capacitor has no significant change in the characteristics of the capacitor in about 30 to 40 GHz band, but exhibits substantially similar capacitor characteristics when composed of an internal electrode pattern 4 and an internal electrode pattern 5, and an internal electrode pattern 3 has the best capacitor characteristics.

Meanwhile, the broadband capacitor has the plate-shaped first electrode set 320 and second electrode set 340 having a “⊥” shape disposed inside the dielectric 100. As the length L1 of the external electrode is changed to 0.17 mm, 0.19 mm, 0.21 mm, 0.23 mm, 0.25 mm, and 0.27 mm, the separation distance L2 between the first external electrode 220 and the second external electrode 240 is formed differently, and the broadband capacitor has the changed frequency band in which resonance occurs and the changed resonance level in each frequency band.

Accordingly, the characteristics of the broadband capacitor according to the embodiment of the present disclosure are improved as the lengths L1 of the first external electrode 220 and the second external electrode 240 increase even when the internal electrode pattern is changed, and the resonance frequency band and the resonance level may be adjusted by adjusting the length L1 of the first external electrode 220 and the length L1 of the second external electrode 240 (i.e., the separation distance L2 between the first external electrode 220 and the second external electrode 240).

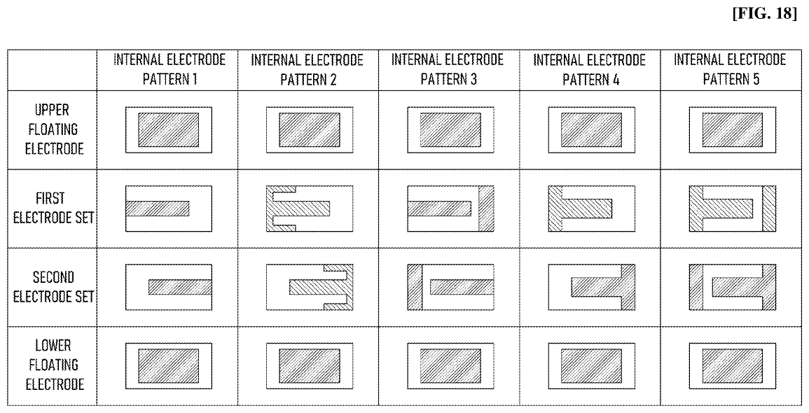

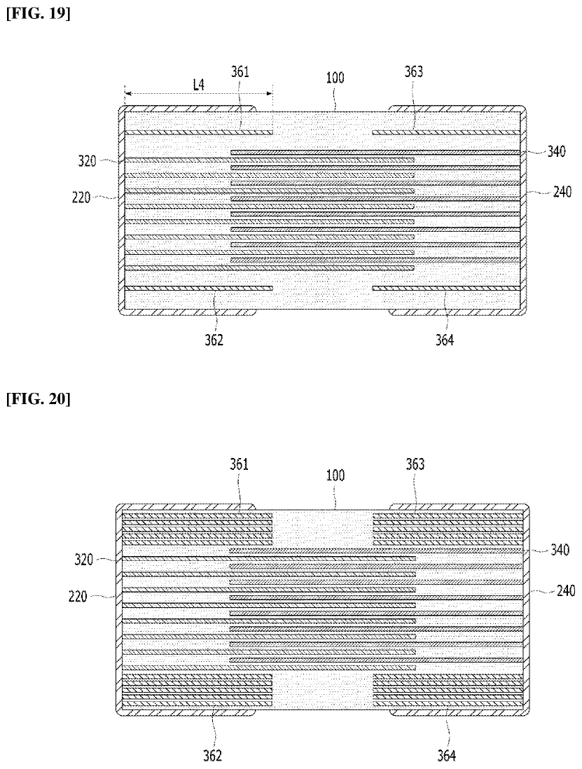

Referring to FIG. 19, the broadband capacitor according to the embodiment of the present disclosure may be configured to further include a plurality of dummy electrodes 360, and may further include, for example, a first dummy electrode 361, a second dummy electrode 362, a third dummy electrode 363, and a fourth dummy electrode 364.

The first dummy electrode 361 is disposed above the laminate in which the plurality of electrode units 300 are laminated. The first dummy electrode 361 is disposed adjacent to the first side surface of the dielectric 100 and connected to the first external electrode 220.

The second dummy electrode 362 is disposed below the laminate in which the plurality of electrode units 300 are laminated. The second dummy electrode 362 is disposed adjacent to the first side surface of the dielectric 100 and connected to the first external electrode 220.

The third dummy electrode 363 is disposed above the laminate in which the plurality of electrode units 300 are laminated. The third dummy electrode 363 is disposed adjacent to the second side surface of the dielectric 100 and connected to the second external electrode 240.

The fourth dummy electrode 364 is disposed below the laminate in which the plurality of electrode units 300 are laminated. The fourth dummy electrode 364 is disposed adjacent to the second side surface of the dielectric 100 and connected to the second external electrode 240.

As a result of measuring an S11 parameter and an S12 parameter while changing the length L4 of the dummy electrode 360 to 0.1 mm, 0.15 mm, 0.2 mm, and 0.25 mm, the tendency to change the length of the dummy electrode 360 may not be significantly seen in the broadband capacitor, but the broadband capacitor exhibits the best capacitor characteristics at about 0.2 mm.

Referring to FIG. 20, the dummy electrode 360 may be configured in a multi-layer structure. In other words, the dummy electrode 360 is, for example, configured by laminating the plurality of dielectric sheets 110 on which the dummy pattern is formed. As a result of measuring the S11 parameter and the S21 parameter by changing the length L4 of the dummy electrode 360 to 0.1 mm, 0.15 mm, 0.2 mm, and 0.25 mm, the capacitor performance is improved when several dummy electrodes 360 are laminated, but the change in the length of the dummy electrode 360 does not significantly affect the capacitor performance.

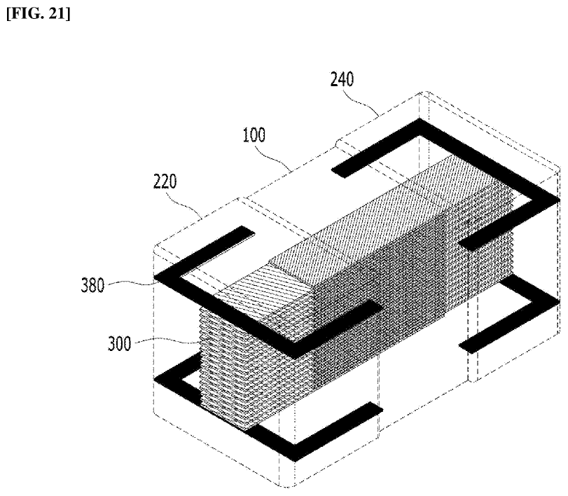

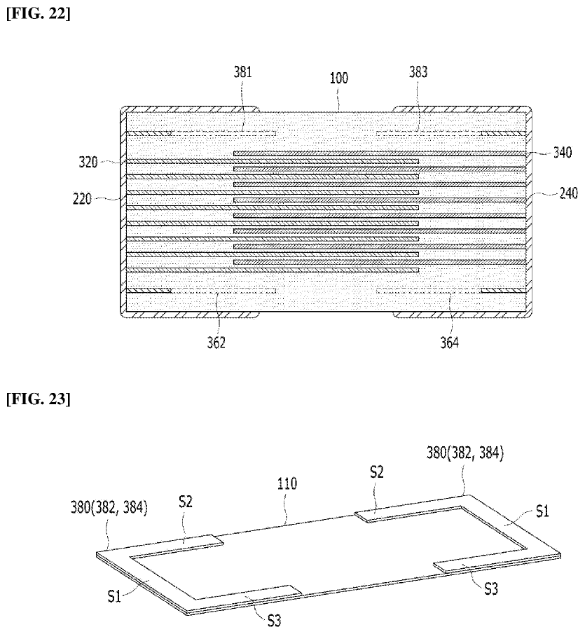

Referring to FIGS. 21 and 22, the broadband capacitor may be configured to further include a stub electrode 380. At this time, the stub electrode 380 includes, for example, a first stub electrode 381, a second stub electrode 382, a third stub electrode 383, and a fourth stub electrode 384.

The first stub electrode 381 is disposed above the laminate in which the plurality of electrode units 300 are laminated. The first stub electrode 381 is disposed adjacent to the first side surface of the dielectric 100 and connected to the first external electrode 220.

The second stub electrode 382 is disposed below the laminate in which the plurality of electrode units 300 are laminated. The second stub electrode 382 is disposed adjacent to the first side surface of the dielectric 100 and connected to the first external electrode 220.

The third stub electrode 383 is disposed above the laminate in which the plurality of electrode units 300 are laminated. The third stub electrode 383 is disposed adjacent to the second side surface of the dielectric 100 and connected to the second external electrode 240. At this time, the third stub electrode 383 is disposed on the same dielectric sheet 110 as the first stub electrode 381 and disposed on the same line as the first stub electrode 381.

The fourth stub electrode 384 is disposed below the laminate in which the plurality of electrode units 300 are laminated. The fourth stub electrode 384 is disposed adjacent to the second side surface of the dielectric 100 and connected to the second external electrode 240. At this time, the fourth stub electrode 384 is disposed on the same dielectric sheet 110 as the second stub electrode 382, and disposed on the same line as the second stub electrode 382.

Referring to FIG. 23, the stub electrode 380 may be formed in a “⊏” shape in which two bends are formed. In other words, the stub electrode 380 may be defined as a first area parallel to the first side surface (or a second side surface) of the dielectric 100, and a second area and a third area parallel to the third side surface (or the fourth side surface) of the dielectric 100. At this time, the second area is connected to a first end of the first area disposed to face the third side surface of the dielectric 100, and the third area is connected to a second end of the first area disposed to face the fourth side surface of the dielectric 100. The second area and the third area may be connected to be perpendicular to the first area.

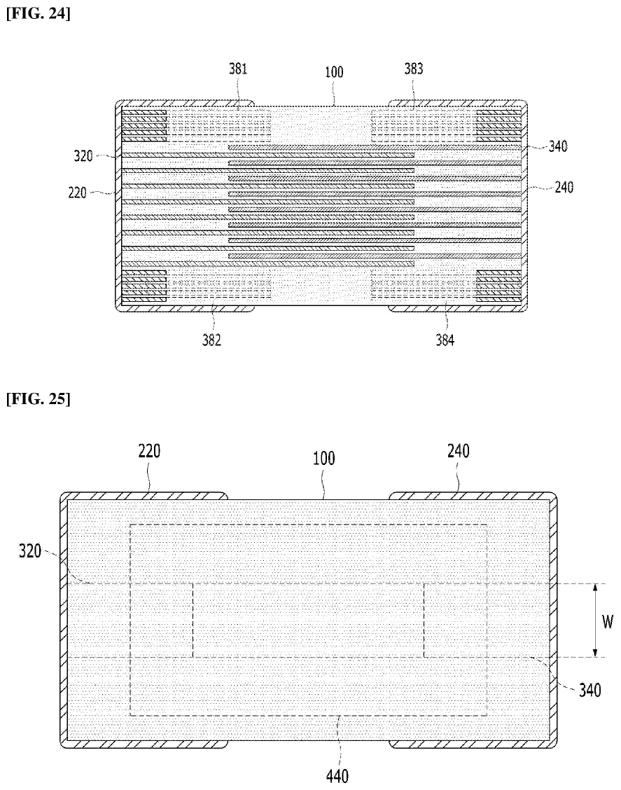

Meanwhile, referring to FIG. 24, the stub electrode 380 may have a multi-layer structure in which a plurality of stub conductors are laminated. In other words, the first stub electrode 381 and the third stub electrode 383 of a multilayer structure are configured by adapting the plurality of dielectric sheets 110 on which a first stub conductor and a third stub conductor are disposed, and the second stub electrode 382 and the fourth stub electrode 384 of a multi-layer structure may be configured by adapting the plurality of dielectric sheets 110 on which a second stub conductor and a fourth stub conductor are disposed.

Although the stub electrode 380 does not significantly affect the capacitor characteristics of the broadband capacitor, the characteristics are slightly changed. Accordingly, the broadband capacitor may finely adjust the characteristics of the capacitor by changing the stub electrode 380, the laminated structure of the stub electrode 380, and the like.

Referring to FIG. 25, the broadband capacitor may also adjust the characteristics of the capacitor by adjusting an electrode width W of the main electrode (i.e., the first main electrode 321 and the second main electrode 341). In other words, the broadband capacitor has the changed frequency band in which resonance occurs and the changed resonance level in each frequency band as the electrode width W of the main electrode is changed to 0.10 mm, 0.15 mm, and 0.20 mm. Accordingly, the broadband capacitor may finely adjust the characteristics of the capacitor by adjusting the electrode width W of the main electrode.

Although the preferred embodiments of the present disclosure have been described above, it is understood that the present disclosure can be modified in various forms, and those skilled in the art can practice various modified examples and changed examples without departing from the scope of the claims of the present disclosure.

1. A broadband capacitor comprising:
a dielectric having an upper surface, a lower surface, a first side surface, a second side surface facing the first side surface, a third side surface, and a fourth side surface facing the third side surface;
a first external electrode disposed on the first side surface of the dielectric, and extending to the upper surface, lower surface, third side surface, and fourth side surface of the dielectric;
a second external electrode disposed on the second side surface of the dielectric, and extending to the upper surface, lower surface, third side surface, and fourth side surface of the dielectric;
a laminate disposed inside the dielectric, and having a plurality of electrode units laminated;
an upper floating electrode disposed inside the dielectric and disposed above the laminate, and overlapping the first external electrode and the second external electrode; and
a lower floating electrode disposed inside the dielectric, disposed below the laminate, and overlapping the first external electrode and the second external electrode.

2. The broadband capacitor of claim 1,
wherein the plurality of electrode units includes;
a first electrode set provided with a first main electrode having a first side connected to the first external electrode; and
a second electrode set provided with a second main electrode having a first side connected to the second external electrode,
the laminate is formed by alternately laminated the first electrode set and the second electrode set,
a second side of the first main electrode is spaced apart from the second external electrode, the second side of the first main electrode is spaced apart from the first external electrode, and a part of the first main electrode overlaps a part of the second main electrode to form an overlapping area, and
the upper floating electrode and the lower floating electrode overlap the overlapping area between the first main electrode and the second main electrode.

3. The broadband capacitor of claim 2,
wherein the first electrode set further includes a first sub-electrode spaced apart from the first main electrode and disposed to face the second side of the first main electrode, and connected to the second external electrode, and
the second electrode set further includes a second sub-electrode spaced apart from the second main electrode and disposed to face a second side of the second main electrode, and connected to the first external electrode.

4. The broadband capacitor of claim 2,
wherein the first electrode set further includes:
a first extension electrode extending from a third side of the first main electrode parallel to the third side surface of the dielectric and extending from a position adjacent to the first side of the first main electrode, and bent toward the second side of the first main electrode from a position spaced apart from the third side of the first main electrode; and
a second extension electrode extending from a fourth side of the first main electrode parallel to the fourth side surface of the dielectric and extending from the position adjacent to the first side of the first main electrode, and bent toward the second side of the first main electrode from a position spaced apart from the fourth side of the first main electrode.

5. The broadband capacitor of claim 2,
wherein the second electrode set further includes:
a third extension electrode extending from a third side of the second main electrode parallel to the third side surface of the dielectric and extending from a position adjacent to the first side of the second main electrode, and bent toward the second side of the first main electrode from a position spaced apart from the third side of the second main electrode; and
a fourth extension electrode extending from a fourth side of the second main electrode parallel to the fourth side surface of the dielectric and extending from the position adjacent to the first side of the second main electrode, and bent toward the second side of the second main electrode from the position spaced apart from the fourth side of the second main electrode.

6. The broadband capacitor of claim 2,
wherein the first electrode set further includes:
a first expansion electrode extending from a third side of the first main electrode parallel to the third side surface of the dielectric and extending toward the third side surface of the dielectric from a position adjacent to the first side of the first main electrode; and
a second expansion electrode extending from a fourth side of the first main electrode parallel to the fourth side surface of the dielectric and extending toward the fourth side surface of the dielectric from the position adjacent to the first side of the first main electrode.

7. The broadband capacitor of claim 2,
wherein the second electrode set further includes:
a third expansion electrode extending from a third side of the second main electrode parallel to the third side surface of the dielectric and extending toward the third side surface of the dielectric from a position adjacent to the first side of the second main electrode; and
a fourth expansion electrode extending from a third side of the second main electrode parallel to the third side surface of the dielectric and extending toward the fourth side surface of the dielectric from the position adjacent to the first side of the second main electrode.

8. The broadband capacitor of claim 1,
wherein the upper floating electrode and the lower floating electrode have a multi-layer structure in which a plurality of dielectric sheets on which a floating electrode is disposed are laminated.

9. The broadband capacitor of claim 1, further comprising:
one or more among a first dummy electrode disposed inside the dielectric and disposed above the laminate, disposed adjacent to the first side surface of the dielectric, and connected to the first external electrode;
a second dummy electrode disposed inside the dielectric and disposed below the laminate, disposed adjacent to the first side surface of the dielectric, and connected to the first external electrode;
a third dummy electrode disposed inside the dielectric and disposed above the laminate, disposed adjacent to the second side surface of the dielectric, and connected to the second external electrode; and
a fourth dummy electrode disposed inside the dielectric and disposed below the laminate, disposed adjacent to the second side surface of the dielectric, and connected to the second external electrode.

10. The broadband capacitor of claim 9,
wherein the first dummy electrode, the second dummy electrode, the third dummy electrode, and the fourth dummy electrode have a multi-layer structure in which a plurality of dielectric sheets on which the dummy electrodes are disposed are laminated.

11. The broadband capacitor of claim 1, further comprising:
one or more among a first stub electrode disposed inside the dielectric and disposed above the laminate, disposed adjacent to the first side surface of the dielectric, and connected to the first external electrode;
a second stub electrode disposed inside the dielectric and disposed below the laminate, disposed adjacent to the first side surface of the dielectric, and connected to the first external electrode;
a third stub electrode disposed inside the dielectric and disposed above the laminate, disposed adjacent to the second side surface of the dielectric, and connected to the second external electrode; and
a fourth stub electrode disposed inside the dielectric and disposed below the laminate, disposed adjacent to the second side surface of the dielectric, and connected to the second external electrode.

12. The broadband capacitor of claim 11,
wherein the first stub electrode, the second stub electrode, the third stub electrode, and the fourth stub electrode have a multi-layer structure in which a plurality of dielectric sheets on which the stub electrodes are disposed are laminated.

13. The broadband capacitor of claim 11,
wherein in the first stub electrode and the second stub electrode,
a first area disposed adjacent to the first side surface of the dielectric, and connected to the first external electrode;
a second area connected to a first end of the first area disposed to face the third side surface of the dielectric; and
a third area connected to a second end of the first area disposed to face the fourth side surface of the dielectric are defined.

14. The broadband capacitor of claim 11,
wherein in the third stub electrode and the fourth stub electrode,
a first area disposed adjacent to the second side surface of the dielectric, and connected to the second external electrode;
a second area connected to a first end of the first area disposed to face the third side surface of the dielectric; and
a third area connected to a second end of the first area disposed to face the fourth side surface of the dielectric are defined.

15. The broadband capacitor of claim 11,
wherein the first stub electrode and the third stub electrode are disposed on a first dielectric sheet disposed above the laminate, and
the second stub electrode and the fourth stub electrode are disposed on a second dielectric sheet disposed below the laminate.
